(19) United States
(12) Patent Application Publication
(10) Pub. No.: US 2008/0101764 A1
(43) Pub. Date: May 1, 2008

(54) Method and Apparatus for Managing Multimedia Content Recording Assets

(75) Inventors: Thomas R. Johannesson, Linkoping (SE); Aner Gusic, Linkoping (SE); Dag Helstad, Linkoping (SE); Stefan Ingvarsson, Linkoping (SE)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/555,329

(22) Filed: Nov. 1, 2006

(51) Int. Cl. H04N 5/91

(52) U.S. Cl. 386/83

(57) ABSTRACT

A device (10) and method (30) for managing multimedia content recording assets, e.g., within a video processing device, such as a video signal convert/decoder (set-top box) device. The method includes receiving multimedia content, storing at least a portion of the multimedia content requested by one or more content assets, and providing access to the stored multimedia content by one or more of the content assets. The multimedia content requested by one or more content assets is stored once in a single location that is not part of any of the content assets. The video processing device includes a processor for receiving multimedia content and a storage device or element for storing received multimedia content. The processor stores received multimedia content once in a storage location that is not part of any of the requesting content assets, and provides access to the stored multimedia content by the requesting content assets.

### BACKGROUND OF THE INVENTION

1. Field of the Invention

The invention relates to recording multimedia content. More particularly, the invention relates to methods and apparatus for improving the management of multimedia content recording assets using video processing devices, such as set-top devices and personal video recording (PVR) devices.

2. Description of the Related Art

Video processing devices, such as video converter/decoder (set-top box) devices, typically include or have access to a hard drive or other storage element for recording streams of multimedia content, such as video streams broadcast from a multimedia content source. Such devices also typically are configured or equipped to record more than one content stream simultaneously.

For example, a first content stream being supplied to a channel currently being watched by an end user can be recorded for current (or future) time-shifting purposes, such as pausing or replaying the “live” channel content. Also, simultaneously, a second content stream being supplied to another (non-watched) channel can be recorded as part of a pre-scheduled program recording session. In such example, the two content streams are recorded to two corresponding content assets.

Also, conventional video processing devices typically are configured or equipped to record the same content stream to more than one content asset. For example, if the content stream supplied to a channel currently being watched by an end user also was previously scheduled to be recorded, the video processing device will record the same content stream to two separate content assets, i.e., a current “live” time-shifting content asset and a pre-scheduled program recording content asset. Also, as another example, if an end user decides that a program currently being watched (and recorded to a first content asset for “live” time-shifting purposes) is a program that the end user wants to save/record for future viewing, the program also will be recorded to a second content asset.

Recording the same content stream to more than one content asset or copying at least a portion of one content asset to another content asset is a relatively inefficient use of video processing device resources, including hard drive storage space and processor bandwidth.

### BRIEF DESCRIPTION OF THE DRAWINGS

FIG. 1 is a block diagram of a video processing device for use in a system for managing multimedia content recording assets;

FIG. 2 is a flow chart that schematically illustrates a method for managing multimedia content recording assets;

FIG. 3 is a block diagram showing conventional storage allocation of multimedia content within a video processing device; and

FIG. 4 is a block diagram showing storage allocation of multimedia content according to a method and apparatus for managing multimedia content recording assets within a video processing device.

### DETAILED DESCRIPTION

In the following description, like reference numerals indicate like components to enhance the understanding of the methods and apparatus for managing multimedia content recording assets through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

The methods and system devices described herein involve the improved management of multimedia content recording assets within video processing devices. Rather than recording the same multimedia content multiple times to multiple storage locations if more than one content asset desires access to the particular multimedia content, the methods and system devices described herein include recording the particular multimedia content once in a single storage location that is not part of any content asset and providing access to the stored content to the plurality of content assets that desire such access. Such management of content recording assets eliminates the need for multiple recording of the same multimedia content, thus freeing up storage space and processing bandwidth for the video processing device.

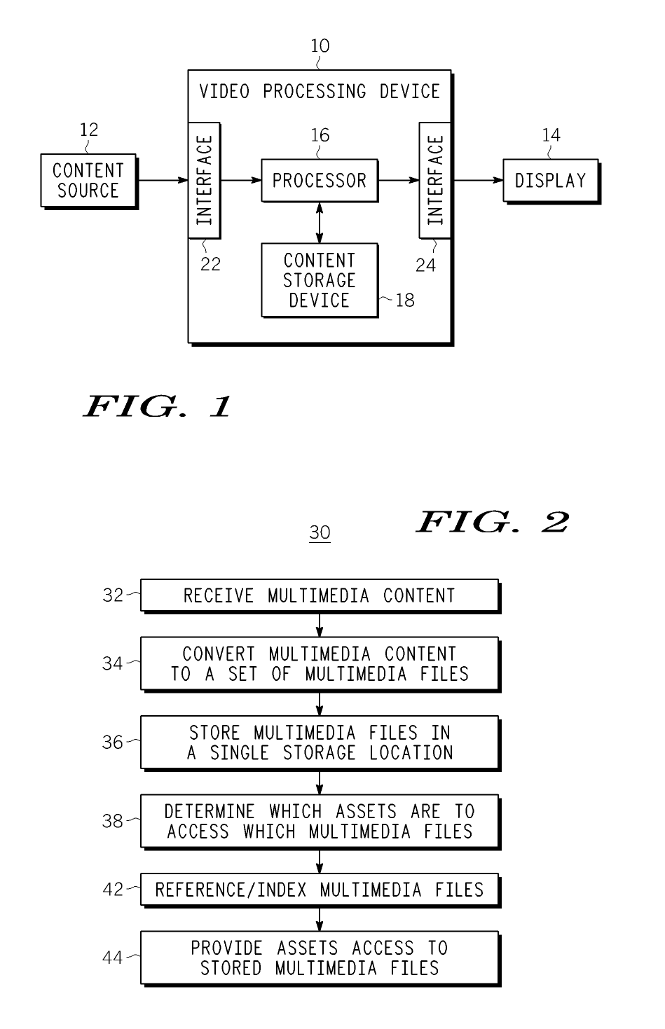

Referring now to FIG. 1, shown is a block diagram of a video processing device 10 for use in a system for managing multimedia content recording assets. The video processing device 10 can be partially or completely any suitable device or subsystem (or portion thereof) for receiving multimedia content from a content source 12 and/or transmitting or transferring processed multimedia content, including stored multimedia content, to an end user display 14, such as a television, computer monitor or other suitable display device. The multimedia content can be any suitable multimedia content, including movies, programming events and other multimedia content, distributed, e.g., as one or more programming streams from a broadcast source or other suitable multimedia content source.

Suitable video processing devices include any multimedia content viewing, processing and/or storing device, such as any digital video recorder (DVR) or digital video server (DVS) device, including signal converter or decoder (set-top) boxes with internal and/or external recording capabilities and local and/or remote storage, which often are referred to as personal video recorder (PVR) devices. Other suitable video processing devices include a residential gateway, a home media server system, a digital video disk recorder, a computer, a television with built-in or added-on video content receiving and storing capability, or other suitable computing devices or video devices, including internet protocol (IP), satellite and cable digital video recorders, and home area network (HAN) systems.

The video processing device 10 includes a processor or processing unit 16 and a content storage element or device 18 coupled to the processor 16. The processor 16 is coupled between a first or input interface 22, which receives multimedia content from the content source 12, and a second or output interface 24, which transfers processed multimedia content, including stored multimedia content, to the end user display 14.

One or more of the processor 16, the content storage device 18 and the interfaces 22, 24 can be comprised partially or completely of any suitable structure or arrangement, e.g., one or more integrated circuits. Also, it should be understood that the video processing device 10 includes other components, hardware and software (not shown) that are used for the operation of other features and functions of the video processing device 10 not specifically described herein.

The video processing device 10 can be partially or completely configured in the form of hardware circuitry and/or other hardware components within a larger device or group of components. Alternatively, the video processing device 10 can be partially or completely configured in the form of software, e.g., as processing instructions and/or one or more sets of logic or computer code. In such configuration, the logic or processing instructions typically are stored in a data storage device, e.g., the content storage device 18 or other suitable data storage device (not shown). The data storage device typically is coupled to a processor or controller, e.g., the processor 16 or other suitable processor or controller (not shown). The processor accesses the necessary instructions from the data storage device and executes the instructions or transfers the instructions to the appropriate location within the video processing device 10.

The content storage device 18 can be any suitable information storage unit, such as any suitable magnetic storage or optical storage device, including magnetic disk drives, magnetic disks, optical drives, optical disks, and memory devices, including random access memory (RAM) devices, and flash memory. Also, although the content storage device 18 is shown within the video processing device 10, the content storage device 18 can be located external to the video processing device 10 and suitably coupled thereto.

Referring now to FIG. 2, with continuing reference to FIG. 1, shown is a flow chart that schematically illustrates a method 30 for a device, such as the video processing device 10, to manage multimedia content recording assets. The method 30 includes a step 32 receiving multimedia content, e.g., by the video processing device 10. Within the video processing device 10, the received multimedia content typically is received from the content source 12 by the input interface 22 and transferred to the processor 16.

As discussed generally hereinabove, multimedia content received by the video processing device 10 can be any suitable multimedia, audio and/or video content, including movies and programming events, from any suitable multimedia content source. The multimedia content received by the video processing device 10 typically is in the form of a multimedia video and/or audio stream comprised of a plurality of digital video and/or audio signals formatted according to a suitable standard, such as the Moving Pictures Experts Group (MPEG) 2 or MPEG 4 standard, and multiplexed into a data stream that is modulated on a carrier using quadrature amplitude modulation (QAM) or other suitable modulation technique.

The multimedia content typically is delivered to the video processing device 10 by a digital cable system, such as a Hybrid Fiber Coaxial (HFC) cable system, or other suitable content stream delivery system. The multimedia content stream also can be an analog video stream, or an Internet Protocol (IP) video stream transmitted over any suitable Fiber To The Premises (FTTP) system, such as Fiber To The Curb (FTTC) or Fiber To The Home (FTTH), or over any suitable number of digital subscriber line systems (xDSL). Alternatively, multimedia content stream can be delivered to the video processing device 10 via a computer network or other suitable network, either through a wired connection or wirelessly.

The method 30 also can include a step 34 of converting the received multimedia content into one or more sets of discrete multimedia files. Video processing devices that provide current or “live” time shifting functions allow an end user to perform trick play functions on the multimedia content currently being viewed on a particular channel. For example, an end user watching content on a particular channel usually can pause, replay and fast forward (e.g., past commercials) the content currently being watched.

To provide such “live” time shifting functionality, the video processing device 10 usually saves or records a sliding window of time to a buffer or other suitable content storage location, e.g., the content storage device 18. For example, the processor 16 temporarily stores the last 60 minutes of content received by the video processing device 10 to a buffer. When the buffer becomes full, the processor 16 will start removing the initially saved portions of the buffered content, usually in discrete size or time intervals, to make room for the more currently received content to be buffered. Thus, the end user typically can perform trick play operations only on the buffered content. If the viewer switches channels, the buffer is deleted and a new sliding window buffer is begun for the content of the new channel.

To be able to maintain the sliding window of buffered content, the stream of received content typically is converted or divided into a set or series of content files. For example, video processing devices record one minute of multimedia content to each file. In this manner, buffered content files can be stored and deleted in one minute increments. It should be understood that other suitable content time and/or size increments can be used. Accordingly, a definable portion of a received content stream, e.g., a single film or programming event, can be converted into a single set of discrete multimedia files.

The method 30 includes a step 36 of storing received multimedia content in a single storage location, e.g., within the content storage device 18 or other suitable location. As will be discussed in greater detail hereinbelow, conventional video processing devices store the same received multimedia content in a different location for each multimedia content asset that requests the use of the multimedia content. For example, if an end user has scheduled the recording of a particular programming event, the programming event will be recorded as a first multimedia content asset in an appropriate storage location, e.g., within the content storage device 18. However, if the end user also happens to be watching the same show, the same content may be recorded again as a second multimedia content asset in a second storage location, e.g., to satisfy the time-shifting functions made available by the video processing device 10 to the end user, regardless of whether the end user makes use of those functions. Thus, if the same content is recorded to several content assets, there will be multiple copies of the same multimedia content on the content storage device. As discussed hereinabove, such duplication unnecessarily expends device resources, including storage space and processor computing capacity.

According to the method 30, the step 36 stores multimedia content only once, in a single storage location, regardless of how many content assets are defined by or request use of such multimedia content. Thus, as soon as a first content asset requests the particular multimedia content or set of multimedia content files, the step 36 is performed to store a single copy of the multimedia content in an appropriate storage location. The multimedia content is stored in any appropriate format, e.g., as a single set of discrete multimedia files, as discussed hereinabove. As will be discussed in greater detail hereinbelow, rather than store the same multimedia content multiple times in multiple content asset storage locations, the multimedia content is stored once (i.e., the step 36) and subsequent steps of the method 30 provide each appropriate content asset with access to the stored content. Thus, unlike conventional arrangements, the stored content will not be part of the content asset, but rather will be stored in a single location suitable for access by the appropriate content assets.

The method 30 includes a step 38 of determining which content assets are to be afforded access to which multimedia content. As soon as one or more content assets requests or otherwise indicates their desire to be afforded access to a particular content stream, e.g., a particular set of multimedia files, the processor 16 or other appropriate component of the video processing device 10 begins storing the content stream, or at least appropriate portions of the content stream, in a single storage location, e.g., within the content storage device 18. Such request can be initiated by an end user, e.g., if the end user wants to record content currently being watched, or by the video processing device 10 itself, e.g., via previously-scheduled instructions for recording particular content.

As part of the determining step 38, a reference count can be kept for each portion of multimedia content, e.g., for each of the multimedia content files within each set of stored multimedia content files. The reference count indicates the specific number of content assets that currently are requesting access to the particular portion of multimedia content. The reference count changes to reflect the addition or removal of content assets requesting access. When the reference count is zero, the processor 16 removes or deletes the particular portion of the stored content from its storage location.

Conventional video processing devices are configured to initiate, terminate, document and otherwise control all aspects of all content recordings and all content asset activity. For example, with respect to content assets and their associated recorded content, conventional video processing devices control and are aware of all content that is being recorded at any given time and for which content asset each content recording is being made. Accordingly, conventional video processing devices already are configured to keep track of, at least indirectly, which content is being recorded, simultaneously or otherwise, to more than one location, i.e., for more than one content asset.

Accordingly, as part of the determining step 38, video processing devices suitable for use in the method 30 for managing the multimedia content recording assets are configured to make use of this existing information to determine which content is to be accessed by more than one content asset, e.g., simultaneously by more than one content asset. Once such determination is made, the method 30 performs a step 42 of providing each requesting content asset with a specific reference to the particular stored multimedia content requested by the content asset. The reference can be in any suitable form, e.g., the specific storage location of the requested content. Also, the reference can be a clock reference, i.e., a reference to a particular amount of elapsed time within the requested content.

The step 42 also can include providing a content asset with specific index points directed to various individual portions within the stored content. For example, the index provided to a content asset can point to a specific position within the stored content, such as a starting point or an ending point to the portion of the stored content that is requested by the content asset. For example, if a time-shifting content asset only requests the last thirty minutes of a stored content program, the step 42 can provide the content asset with an index to the beginning of the last thirty minutes of the stored content. The content asset thus would not have indexed access to earlier portions of the stored content, although a subsequent request by the content asset can provide the content asset with reference to and/or an index to such earlier portions of the stored content.

Alternatively, the indexes can be shared by more than on content asset. The index information can be the same information for content assets sharing the same multimedia files. Therefore, the stored multimedia files can include appropriate index information, which is shared by content assets along with the corresponding multimedia files. For example, in this manner, the content assets contain metadata or other information about the multimedia files the content assets have access to.

The method 30 also includes a step 44 of providing the appropriate content assets with access to portions of the stored content. Access to the stored content by the content assets is controlled by the references and/or indexes provided to the content assets. For example, a time-shifting content asset may have a reference to 20 minutes of a particular stored content stream. Such reference allows the content asset to access the content files representing the 20 minutes of the stored content associated with the reference provided to the content asset. As discussed hereinabove, the files containing the stored content are not part of the content asset. Rather, the content assets include references and/or indexes to particular portions/files of the stored content, thus allowing the content assets to share the same content files stored in a single location accessible by more than one content asset.

In addition to reducing the amount of storage space needed for content storage and the amount of processing power associated with the read and write operations associated with storing multiple copies of the same content, the method 30 also improves efficiency associated with copying a content asset, or portions of a content asset, to a new asset. For example, as discussed hereinabove, if an end user decides that the program currently being watched (and recorded for a first content asset for “live” time-shifting purposes) is a program that the end user wants to save/record for future viewing (a second content asset), conventional methods require that at least a portion of the first content asset be copied to the second content asset and other parts of the same stream be copied to both content assets. In addition to being relatively resource intensive, such conventional activity often is not seamless to an end user, as switching from asset-to-asset copying to stream-to-asset copying often can not be made in a manner than appears seamless to the end user. However, according to the method 30, no additional copying of content assets or streaming content is needed in this scenario. The new content asset simply is provided with a reference and/or index to the stored content the content asset wants to access, and the appropriate reference count is increased by one. Such activity is not noticeable by an end user viewing the content referenced by either content asset.

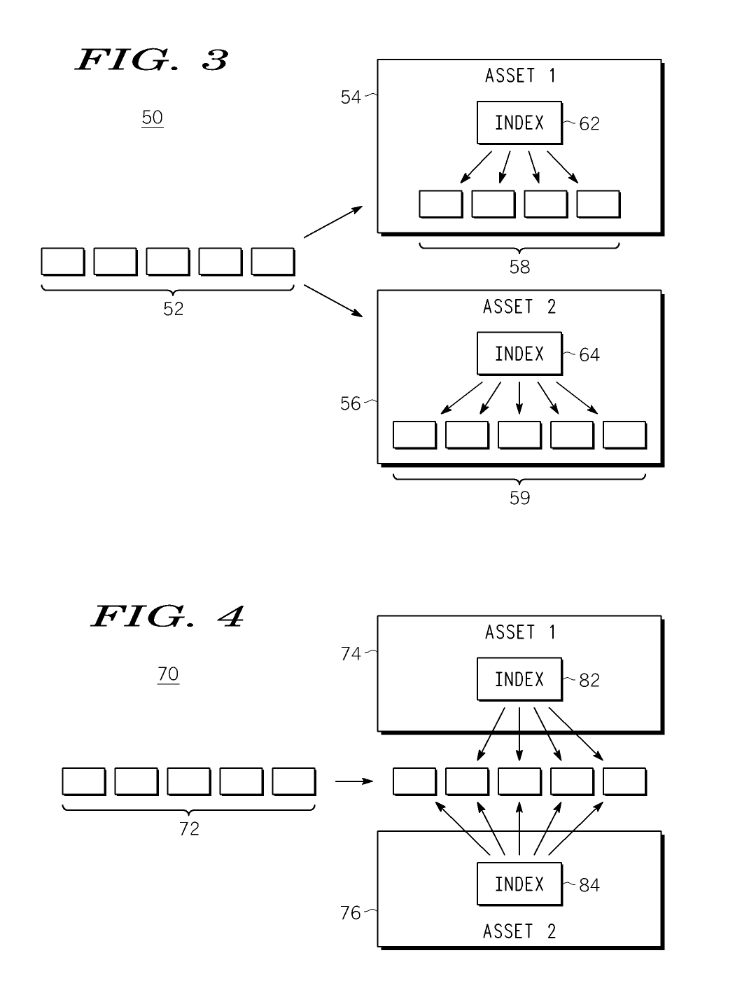

Referring now to FIG. 3, shown is a block diagram 50 showing conventional storage allocation of multimedia content within a video processing device. As discussed previously herein, in conventional arrangements, multimedia content requested by more than one content asset is written to or stored in each of the requesting content assets. In the conventional arrangement shown, multimedia content, e.g., in the form of a set of 5 multimedia content files 52, is requested by both a first content asset 54 and a second content asset 56. In this example, the first content asset 54 requests 4 of the 5 multimedia content files 52, and the second content asset 56 requests all 5 of the 5 multimedia content files 52.

As shown, the set of multimedia content files 52, or at least a portion thereof, is written or stored twice. That is, the set of multimedia content files 52 is physically written to two separate storage locations, a first storage location associated with the first content asset 54 and a second storage location associated with the second content asset 56. More specifically, 4 of the 5 multimedia content files 52 are written to the first content asset 54 (shown as 58), and 5 of the 5 multimedia content files 52 are written to the second content asset 56 (shown as 59). Thus, in this example, at least 4 of the same multimedia files within the set of multimedia files 52 end up being physically located in two separate storage locations.

The first content asset 54 includes an index 62 for accessing the 4 multimedia content files stored in the first content asset 54. Similarly, the second content asset 56 includes an index 64 for accessing the 5 multimedia content files stored in the second content asset 56. When either of the content assets 54, 56 no longer has use for any one or more of the respective multimedia content files stored therein, the particular multimedia content files are deleted from the respective first content asset.

Referring now to FIG. 4, shown is a block diagram 70 showing storage allocation of multimedia content according to a method and apparatus for managing multimedia content recording assets within a video processing device, as described hereinabove. Unlike conventional arrangements, in this arrangement, multimedia content, e.g., in the form of a set of 5 multimedia content files 72, is not written to each requesting content asset, e.g., a first content asset 74 and a second content asset 76. Rather, according to the method 30 for managing multimedia content recording assets described hereinabove, the multimedia content files 72 are written to a single storage location and access thereto is provided to the requesting content assets.

The first content asset 74 includes an index 82 for accessing the 4 multimedia content files, like in the conventional arrangement shown in FIG. 3. However, unlike the conventional arrangement shown in FIG. 3, the index 82 indexes or provides access to multimedia content files that are not stored within the content asset 74 itself. Rather, as discussed, the index 82 provides access to multimedia content files stored in a single storage location that is not part of the content asset, but that is accessible by more than one content asset, e.g., the first content asset 74 and the second content asset 76. Similarly, the second content asset 76 includes an index 84 that accesses at least a portion of the same multimedia content files 72.

As discussed hereinabove, in the arrangement shown in FIG. 4, multimedia content files are not stored or copied multiple times to multiple storage locations, thus preserving storage space, e.g., within the content storage device content storage device 18 in the video processing device 10. Also, reducing the amount of processing instructions associated with storing multimedia content frees up processing resources for other operations, thus improving the overall efficiency of the video processing device 10.

The method shown in FIG. 2 may be implemented in a general, multi-purpose or single purpose processor. Such a processor will execute instructions, either at the assembly, compiled or machine-level, to perform that process. Those instructions can be written by one of ordinary skill in the art following the description of FIG. 2 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the methods and apparatus for managing multimedia content recording assets herein described without departing from the spirit and scope of the invention as defined by the appended claims and their full scope of equivalents.

1. A method for managing the recording of multimedia content to a plurality of multimedia content assets, the program comprising:
receiving multimedia content;
storing the multimedia content in a single storage location that is not a part of any of the plurality of multimedia content assets but that is accessible by more than one multimedia content asset; and
providing at least one of the multimedia content assets access to at least a portion of the multimedia content.

2. The method as recited in claim 1, wherein at least one of the plurality multimedia content assets includes an index of which portions of the stored multimedia content is to be accessed by the respective multimedia content asset.

3. The method as recited in claim 1, further comprising:
determining if more than one of the plurality of multimedia content assets is to access the stored multimedia content.

4. The method as recited in claim 1, wherein:
at least a portion of the stored multimedia content has a reference count associated therewith that indicates how many of the plurality of multimedia content assets are accessing the stored portion of the multimedia content, and further comprising: deleting portions of the stored multimedia content whose reference count is zero.

5. The method recited in claim 1, wherein the providing instructions includes referencing at least a portion of the stored multimedia content.

6. The method as recited in claim 5, further comprising referencing at least one clock reference to at least a portion of the stored multimedia content.

7. The method as recited in claim 1, further comprising:
converting the received multimedia content to a set of multimedia content files, wherein the storing instructions further comprise storing the set of multimedia content files in a single storage location that is accessible by more than one multimedia content asset, and wherein the providing instructions further comprise instructions for providing at least one of the multimedia content assets access to at least a portion of the set of multimedia content files.

8. A device for managing the recording of multimedia content to a plurality of multimedia content assets, comprising:
a processor configured to receive multimedia content from a multimedia content source; and
at least one memory element coupled to the processor for storing multimedia content received by the device,
wherein the processor is configured to store no more than one version of the multimedia content in a single storage location within the memory element, wherein the multimedia content storage location is not a part of any storage location of the plurality of multimedia content assets, and
wherein the processor is configured to allow access to the stored version of the multimedia content by more than one multimedia content asset.

9. The device as recited in claim 8, wherein the processor is configured to allow at least one of the plurality of multimedia content assets to index at least a portion of the stored multimedia content.

10. The device as recited in claim 8, wherein the processor is configured to allow at least one of the plurality of multimedia content assets to reference at least a portion of the stored multimedia content for access thereto.

11. The device as recited in claim 8, wherein the processor is configured to keep a reference count of which of the plurality of multimedia content assets are indexed to access at least a portion of the stored multimedia content.

12. The device as recited in claim 11, wherein the processor is configured to delete portions of the stored multimedia content from the memory element when no multimedia content assets are indexed to access the stored portion of the multimedia content.

13. The device as recited in claim 8, wherein the processor is configured to provide at least one clock reference for at least one of the plurality of multimedia content assets that is indexed to access at least a portion of the stored multimedia content.

14. The device as recited in claim 8, wherein the processor is configured to determine if more than one of the plurality of multimedia content assets is to access at least a portion of the stored multimedia content.

15. The device as recited in claim 8, wherein the processor is configured to convert received multimedia content to a set of multimedia content files, to store no more than one version of the set of multimedia content files in the memory element, and to allow access to the stored version of the set of multimedia content files by more than one multimedia content asset.

16. The device as recited in claim 8, wherein at least a portion of the device is contained in a video processing device.

17. The device as recited in claim 16, wherein the video processing device is selected from the group consisting of a signal converter box, a signal decoder box, a digital video recorder, a digital video disk recorder, a personal video recorder device, a home media server, a digital video server, a residential gateway, a video receiver and a computer.
